(19) United States
(12) Patent Application Publication
(10) Pub. No.: US 2010/0290519 A1
(43) Pub. Date: Nov. 18, 2010

(54) APPARATUS AND METHOD FOR SUPPORTING SCALABILITY TECHNIQUE IN VIDEO COMMUNICATION SYSTEM

(75) Inventor: Wook-Hyun JEONG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/724,528

(22) Filed: Mar. 16, 2010

(30) Foreign Application Priority Data
May 14, 2009 (KR) 10-2009-0042098

(51) Int. Cl. H04N 11/02

(52) U.S. Cl. 375/240.01; 375/E07.026

(57) ABSTRACT

Provided are an apparatus and method for supporting a scalability technique in a video communication system. The apparatus includes: a communication unit, disposed in a modem chip, receiving an enhanced layer bit string and a basic layer bit string of a video for video communication; a second video decoder, disposed in the modem chip, restoring low resolution video data from the basic layer bit string; a first decoder, disposed in a PDA chip, restoring high resolution video data from the low resolution video data and the enhanced layer bit string; and a control unit providing the low resolution video data to the first video decoder.

### CLAIM OF PRIORITY

This application claims the benefit of an earlier patent application No. 10-2009-0042098 filed in the Korean Intellectual Property Office on May 14, 2009, the contents of which are incorporated herein by reference in its entirety.

### BACKGROUND OF THE INVENTION

1. Field of the Invention

The present invention relates generally to a video communication system. More particularly, the present invention relates to an apparatus and method for supporting a scalability technique in a video communication system.

2. Description of the Related Art

In MPEG-2 and MPEG-4, a spatial scalability technique and a temporal scalability technique are implemented for transmission. Briefly, the spatial scalability technique encodes and transmits an original video with a basic layer 110 and an enhanced layer 120 to have respectively different resolutions as shown in FIG. 1A. The temporal scalability technique encodes and transmits an original video with a basic layer 130 and an enhanced layer 140 to have the respectively different number of frames per sec as shown in FIG. 1B. At the receiving end, a receiving unit decodes a bit string of the basic layers 110 and 130 and additionally decodes a bit string of the enhanced layers 120 and 140 according to resource capacity, such that a video of high resolution may be played spatially or temporally.

In order to apply the scalability technique, the transmitting unit needs to include a plurality of encoders for encoding each layer and also the receiving unit needs to include a plurality of decoders for decoding each layer. However, terminals for supporting an MPEG based video communication typically include a single chip structure equipped with only a modem. Accordingly, without additional digital signal processing (DSP) chip mounting thereon, the scalability technique cannot be applied. Moreover, in a case of a compound terminal using two chips such as a personal digital assistant (PDA) chip and a modem chip, only one of the two chips performs encoding and decoding during video communication since the PDA chip is designed without communication functions. That is, in order to apply the scalability technique, the compound terminal or like requires additional DSP chip.

Therefore, a new scheme is needed incorporate the scalability technique to a current terminal, without requiring additional DSP chip mounting.

### SUMMARY OF THE INVENTION

An exemplary aspect of the present invention is to substantially address at least the above problems and/or disadvantages and to provide at least the advantages below. Accordingly, an object of the present invention is to provide an apparatus and method for applying a scalability technique to a compound terminal in a video communication system.

Another exemplary aspect of the present invention is to provide an apparatus and method for applying a scalability technique to a compound terminal in a video communication system without additional digital signal processing (DSP) chip mounting.

According to an exemplary aspect of the present invention, a compound terminal having a video communication function includes: a first video encoder, disposed in a personal digital assistant (PDA) chip, generating an enhanced layer bit sting for a high resolution video; a second video encoder, disposed in a modem chip, generating a basic layer bit string for a low resolution video; a control unit providing the enhanced layer bit string to the modem chip; and a communication unit, disposed in the modem chip, transmitting the enhanced layer bit string and the basic layer bit string.

According to another exemplary aspect of the present invention, a compound terminal having a video communication function includes: a communication unit, disposed in a modem chip, receiving an enhanced layer bit string and a basic layer bit string of a video for video communication; a second video decoder, disposed in the modem chip, restoring low resolution video data from the basic layer bit string; a first decoder, disposed in a PDA chip, restoring high resolution video data from the low resolution video data and the enhanced layer bit string; and a control unit providing the low resolution video data to the first video decoder.

According to another exemplary aspect of the present invention, an image transmitting method of a compound terminal having a video communication function includes: generating an enhanced layer bit string for a high resolution video using a first video encoder in a PDA chip; generating a basic layer bit string for a low resolution video using a second video encoder in a modem chip; and transmitting the enhanced layer bit string and the basic layer bit string.

According to another exemplary aspect of the present invention, an image receiving method of a compound terminal having a video communication function includes: receiving an enhanced layer bit string and a basic layer bit string of a video for video communication; restoring low resolution video data from the basic layer bit string using a second video decoder in a modem chip; and restoring high resolution video data from the low resolution video data and the enhanced layer bit string using a first video decoder in a PDA chip.

### BRIEF DESCRIPTION OF THE DRAWINGS

The above features and advantages of the present invention will become more apparent from the following detailed description when taken in conjunction with the accompanying drawings in which:

FIG. 1A and FIG. 1B are conceptual views illustrating a scalability technique provided from an MPEG;

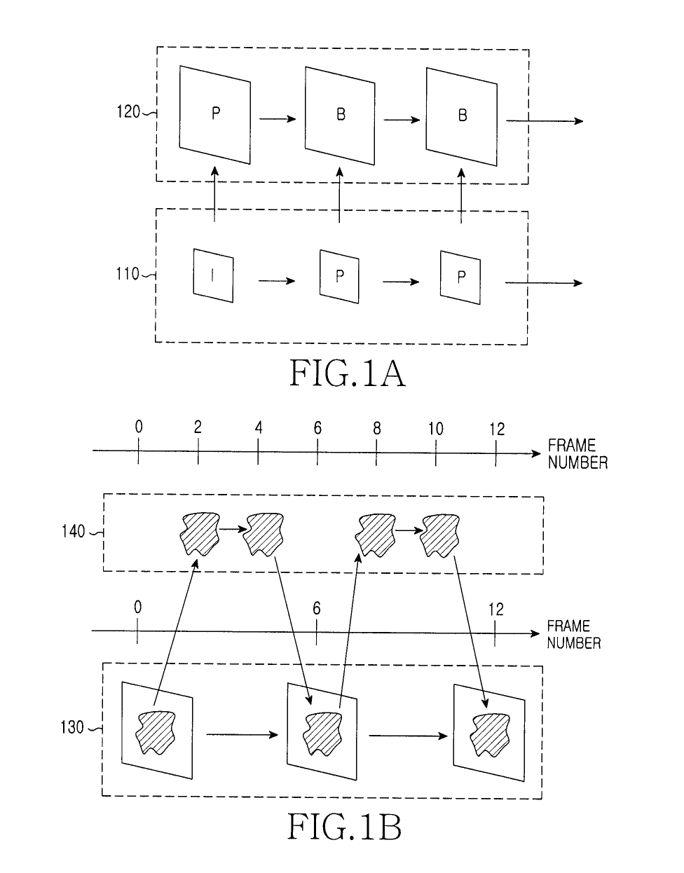

FIG. 2 is a block diagram illustrating a transmitting unit of a video communication system according to an embodiment of the present invention;

FIG. 3 is a block diagram illustrating a receiving unit of a video communication system according to an embodiment of the present invention;

FIG. 4 is a flowchart illustrating operational procedures of a transmitting unit in a video communication system according to an embodiment of the present invention; and

FIG. 5 is a flowchart illustrating operational procedures of a transmitting unit in a video communication system according to an embodiment of the present invention.

### DETAILED DESCRIPTION

The following description, with reference to the accompanying drawings, is provided to assist a person of ordinary skill in the art with a comprehensive understanding of exemplary embodiments of the present invention as defined by the claims. The description includes various specific details to assist in that understanding but these details are to be regarded as merely exemplary. Accordingly, those of ordinary skill in the art will recognize that various changes and modifications of the exemplary embodiments described herein can be made without departing from the scope and spirit of the invention as defined by the appended claims. For the purposes of clarity and simplicity, descriptions of well-known functions and constructions may be omitted for conciseness and so as not to obscure appreciation of the present invention by a person of ordinary skill with such well-known functions and constructions.

Hereinafter, the present invention provides an apparatus and method for applying a scalability technique to a compound terminal in a video communication system without additional digital signal processing (DSP) chip mounting. Hereinafter, the compound terminal in the specification represents a mobile communication terminal with a personal digital assistant (PDA) function, and specifically a terminal having a PDA chip and a modem chip.

The teachings of the present invention are applicable to an encoding/decoding unit of a PDA chip and an encoding/decoding unit of a modem chip in order to apply a spatial scalability technique or a temporal scalability technique to the compound terminal without requiring an additional DSP chip. More specifically, the encoding/decoding unit in the modem processes a bit string of a basic layer and the encoding/decoding unit in the PDA chip processes a bit string of an enhanced layer.

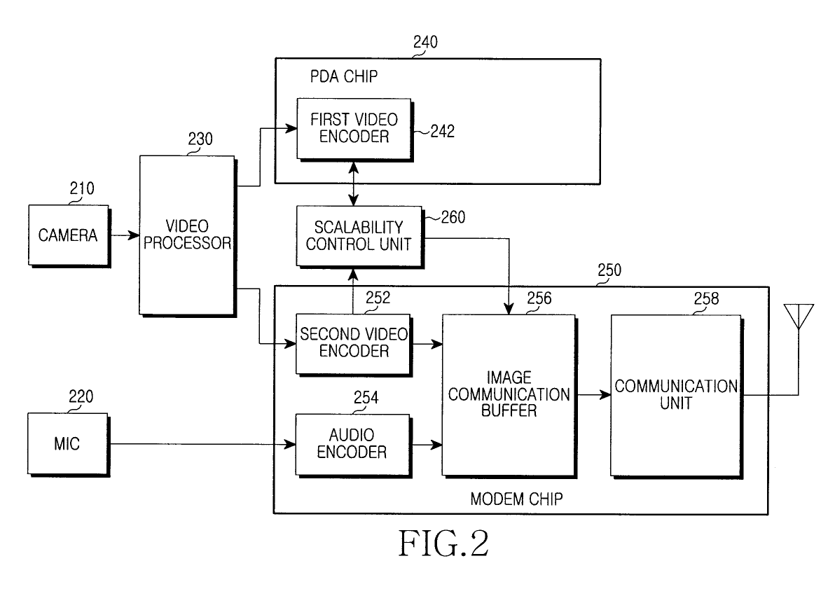

FIG. 2 is a block diagram illustrating a transmitting unit of a video communication system according to an embodiment of the present invention.

As shown in FIG. 2, the transmitting unit includes a camera 210, a microphone (MIC) 220, a video processor 230, a PDA chip 240, a modem chip 250, and a scalability control unit 260.

The camera 210 converts light into an electrical signal and provides the converted electrical signal of an image to the video processor 230. The camera 210 includes a lens and an optical sensor and converts light inputted through the lens into an electrical signal using the optical sensor. The MIC 220 converts voice into an electrical signal and provides the converted electrical signal of voice to the modem chip 250.

The video processor 230 generates video data using electrical signals of an image provided from the camera 210. The video processor 230 generates high resolution video data provided from signals from the camera 210 and generates low resolution video from the high resolution video data. At this point, when the spatial scalability technique is applied, the video processor 230 generates low resolution video data by down-sampling an image of the high resolution video data. When the temporal scalability technique is applied, the video processor 230 generates low resolution video data by sampling frames of the high resolution video data. Then, the video processor 230 provides the high resolution video data to the PDA chip 240 and the low resolution video data to the modem chip 250, respectively.

The PDA chip 240 performs functions for the PDA steps. Especially, the PDA chip 240 includes a first video encoder 242 for generating an enhanced bit string using the high resolution video data provided from the video processor 230. The first video encoder 242 generates the enhanced layer bit string using the low resolution video data provided from the scalability control unit 260 and the high resolution video data provided from the video processor 230. In more detail, the first video encoder 242 generates expanded low resolution video data from the above low resolution video data through up-sampling. At this point, when the spatial scalability technique is applied, the extended low resolution video data increases a screen size and includes a portion of pixels. When the temporal scalability technique is applied, the extended low resolution video data increases the number of frames and includes a portion of frames. Next, the first video encoder 242 obtains video data difference between the high resolution video data and the extended low resolution video data, then encodes the difference to generate an enhanced layer bit string. For example, the first video encoder 242 may perform video encoding according to an MPEG-2 or MPEG-4 standard.

The modem chip 250 performs functions for the communication steps. Especially, the modem chip 240 includes a second video encoder 242 for generating a basic layer bit string, an audio encoder 254, a video communication buffer 245, and a communication unit 258. The second video encoder 252 encodes low resolution video data provided from the video processor 230 to generate a basic layer bit string and provides the low resolution video data to the scalability control unit 260. At this point, the second video encoder 252 provides the low resolution video data provided from the video processor 230 to the scalability control unit 260 as they are. Or, the second video encoder 252 decodes the encoded low resolution video data and then provides the decoded low resolution video data to the scalability control unit 260 as they are. That is, the second video encoder 252 includes a video decoding function. Here, the second video encoder 252 performs video encoding or decoding according to an MPEG-2 or MPEG-4 standard.

The audio encoder 254 generates an audio bit string from a voice signal provided from the MIC 220. The video communication buffer 256 multiplexes the audio bit string, the basic layer bit string, and the enhanced layer bit string and then provides them to the communication unit 258. The communication unit 258 modulates bit strings provided from the video communication buffer 256 according to a communication standard and up-converts the modulated bit strings to a signal of a radio frequency (RF) band, and then transmits the RF signals through an antenna.

The scalability control unit 260 performs functions to apply the scalability technique to a video for video communication. The scalability control unit 260 receives a basic layer bit string from the second video encoder 252 and provides the received basic layer bit string to the first video encoder 242. Accordingly, when the enhanced layer bit string is provided from the first video encoder 242, the scalability control unit 260 provides the enhanced layer bit string to the image communication buffer 256.

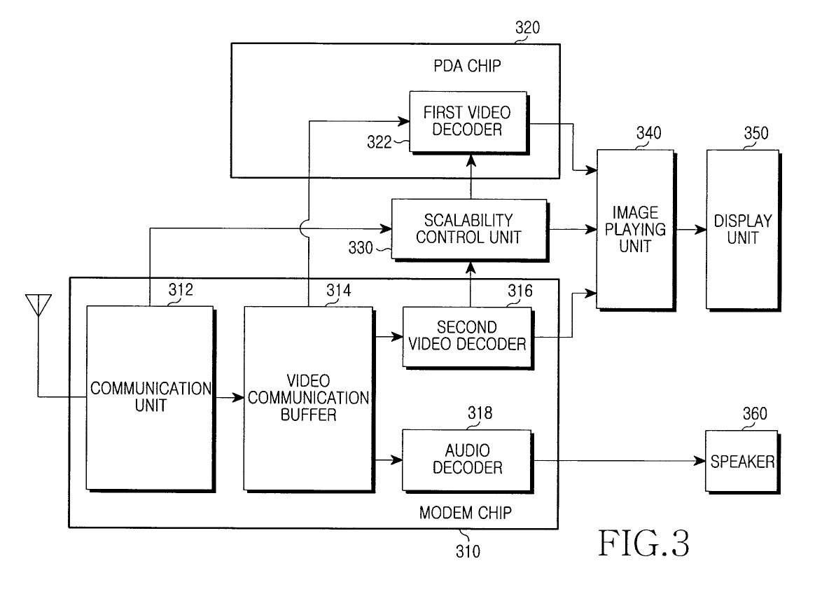

FIG. 3 is a block diagram illustrating a receiving unit in a video communication system according to an embodiment of the present invention.

As shown in FIG. 3, the receiving unit includes a modem chip 310, a PDA chip 320, a scalability control unit 330, an image playing unit 340, a display unit 350, and a speaker 360.

The modem chip 310 performs functions for the communication operations. Especially, the modem chip 310 includes a communication unit 312, an image communication buffer 314, a second video decoder 316, and an audio decoder 318. The communication unit 312 down-converts and demodulates an RF band signal received through an antenna to restore bit strings including an enhanced layer bit string, a basic layer bit string, and an audio bit string. The image communication buffer 314 de-multiplexes the bit strings into the enhanced layer bit string, the basic layer bit string, and the audio bit string. Moreover, the image communication buffer 314 provides the enhanced bit sting into the scalability control unit 330, provides the basic layer bit string to the second video decoder 316, and provides the audio bit string to the audio decoder 318. The second video decoder 316 decodes the basic layer bit string to restore the low resolution video data. For example, the second video decoder 316 performs video decoding according to an MPEG-2 or MPEG-4 standard. The audio decoder 318 decodes the audio bit string to restore audio data.

The PDA chip 320 performs functions for the PDA operations. Especially, the PDA chip 320 includes a first video decoder 322 for restoring high resolution video data using the enhanced layer bit string. The first video decoder 322 restores the high resolution video data using the enhanced layer bit string and low resolution video data, provided from the scalability control unit 220. In more detail, the first video decoder 322 decodes the enhanced layer bit string to restore difference video data. Then, the first video decoder 322 generates expanded low resolution video data through up-sampling. At this point, when the spatial scalability technique is applied, the extended low resolution video data increases a screen size and includes a portion of pixels. When the temporal scalability technique is applied, the extended low resolution video data increases the number of frames and includes a portion of frames. Next, the first video decoder 322 restores high resolution video data by combining the expanded low resolution video data and the difference in video data. For example, the first video decoder 322 performs video decoding according to an MPEG-2 or MPEG-4 standard.

The scalability control unit 330 performs functions to apply the scalability technique to a video for video communication. That is, the scalability control unit 330 determines whether the enhanced layer bit string is decoded or not based on a channel status of the transmitting unit, that is, whether the scalability technique is applied or not. For example, the scalability control unit 330 calculates a scalability determination index using a packet error rate or a channel quality value provided from the communication unit 312, and determines that the scalability technique is applied if the scalability determination index is more than a critical value. Then, the scalability control unit 330 provides the enhanced layer bit string provided from the image communication buffer 314 and the low resolution video data provided from the second video decoder 316, to the first video decoder 322. Thereafter, the scalability control unit 330 controls a video data output of the first video decoder 322 and the second video decoder 316, which is outputted to the image playing unit 340.

The image playing unit 340 converts the high resolution video data provided from the first video decoder 322 or the low resolution video data provided from the second video decoder 316, into an electrical signal according to properties of the display unit 350. The display unit 350, as an image output means, visually displays an electrical signal of an image provided from the image playing unit 340. For example, the display unit 350 includes a liquid crystal display (LCD) and an organic light-emitting diode (OLED). The speaker 360, as an audio output means, acoustically outputs an audio signal provided from the audio decoder 318.

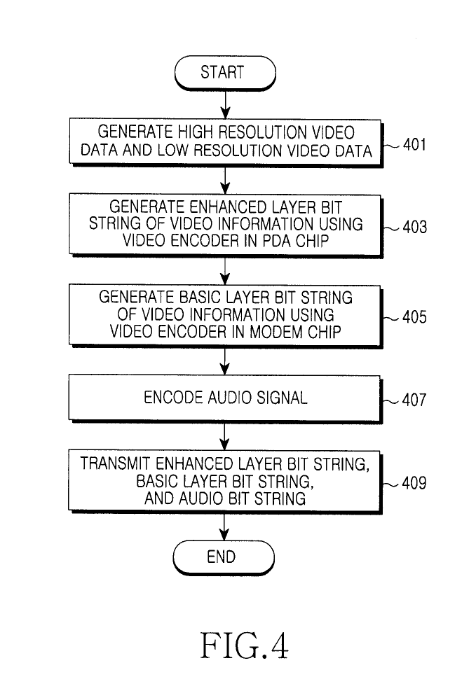

FIG. 4 is a flowchart illustrating operational procedures of a transmitting unit in a video communication system according to an embodiment of the present invention.

Referring to FIG. 4, the transmitting unit generates high resolution video data and low resolution video data in step 401. That is, the transmitting unit generates the high and low resolution video data by using two cameras with respectively different resolutions or extracts low resolution video data from an image captured by one camera. At this point, the resolution reference is a screen size or the number of frames.

Next, the transmitting unit proceeds to step 403 to generate an enhanced layer bit sting of video information using a video encoder in a PDA chip. In more detail, the transmitting unit generates low resolution video data extending from the low resolution video data through up-sampling. At this point, when the spatial scalability technique is applied, the extended low resolution video data increases a screen size and includes a portion of pixels. When the temporal scalability technique is applied, the extended low resolution video data increases the number of frames and includes a portion of frames. Next, the transmitting unit obtains video data difference between the high resolution video data and the extended low resolution video data, then encodes the difference to generate an enhanced layer bit string. For example, the transmitting unit performs video encoding according to an MPEG-2 or MPEG-4 standard.

Simultaneously, the transmitting unit proceeds to step 405 to generate a basic layer bit sting of video information using a video encoder in a modem chip. That is, the transmitting unit generates the basic layer bit sting by encoding the low resolution video data. For example, the transmitting unit performs video encoding according to an MPEG-2 or MPEG-4 standard.

Next, the transmitting unit proceeds to step 407 to encode an audio signal. That is, the transmitting unit encodes an audio signal inputted through a MIC to generate an audio bit string.

Next, the transmitting unit proceeds to step 409 to transmit the enhanced layer bit string, the basic layer bit string, and the audio bit string. That is, the transmitting unit multiplexes the enhanced layer bit string, the basic layer bit string, and the audio bit string, and then demodulates transmission bit strings including the enhanced layer bit string, the basic layer bit string, and the audio bit string. Then, the transmitting unit up-converts the demodulated transmission bit strings into an RF band signal to transmit the up-converted signal through an antenna.

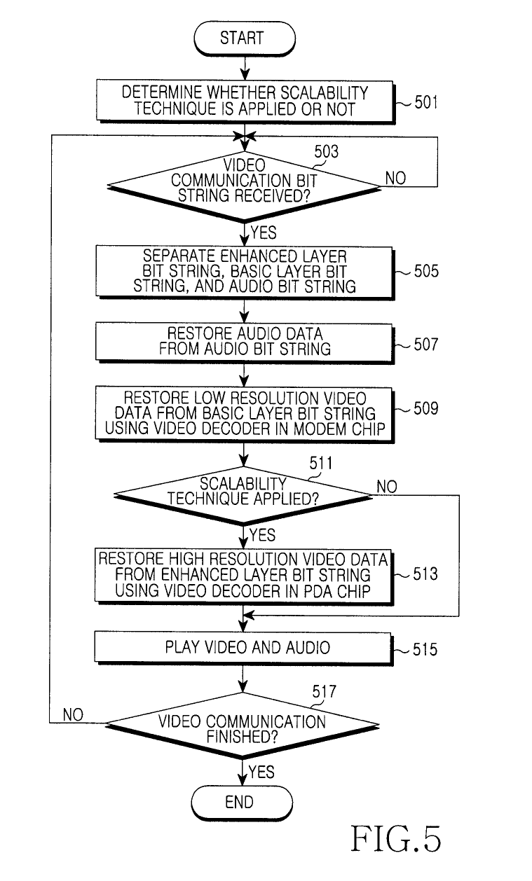

FIG. 5 is a flowchart illustrating operational procedures of a transmitting unit in a video communication system according to an embodiment of the present invention.

Referring to FIG. 5, the receiving unit determines whether the enhanced layer bit string is decoded or not based on a channel status of the transmitting unit during video communication, that is, whether the scalability technique is applied or not in step 501. For example, the receiving unit calculates a scalability determination index using a packet error rate or a channel quality value, and determines that the scalability technique is applied if the scalability determination index is more than a critical value.

Next, the receiving unit proceeds to step 503 to determine whether a video communication bit string is received or not. That is, the receiving unit determines whether video communication packets are received through a call that is generated for the video communication.

Next, when the video communication bit string is received, the receiving unit proceeds to step 505 to separate the video communication bit string into an enhanced layer bit string, a basic layer bit string, and an audio bit string.

Next, the receiving unit proceeds to step 507 to restore audio data from the audio bit string. That is, the receiving unit restores the audio data by decoding the audio bit string according to a corresponding audio standard.

Next, the receiving unit proceeds to step 509 to restore low resolution video data from the basic layer bit sting using a video decoder in a modem chip. That is, the receiving unit decodes the basic layer bit string to restore the low resolution video data. For example, the transmitting unit performs video encoding according to an MPEG-2 or MPEG-4 standard.

At this point, the receiving unit proceeds to step 511 to determine whether the scalability technique is applied or not. That is, the receiving unit determines whether the scalability technique is applied or not in the step 501.

If the scalability technique is applied, the receiving unit proceeds to step 513 to restore low resolution video data from the enhanced layer bit sting using a video decoder in a PDA chip. In more detail, the receiving unit decodes the enhanced layer bit string to restore difference video data. Then, the receiving unit generates expanded low resolution video data through up-sampling. At this point, when the spatial scalability technique is applied, the extended low resolution video data increases a screen size and includes a portion of pixels. When the temporal scalability technique is applied, the extended low resolution video data increases the number of frames and is includes a portion of frames. Next, the receiving unit restores high resolution video data by combining the expanded low resolution video data and the difference in video data. For example, the receiving unit performs video decoding according to an MPEG-2 or MPEG-4 standard.

Next, the receiving unit proceeds to step 515 and plays the video data restored in the step 509 or the step 513 and the audio data restored in the step 507. At this point, if step 513 is performed (i.e., if the scalability technique is applied), the receiving unit plays high resolution video data. On the contrary, if the step 513 is not performed (i.e., if the scalability technique is not applied), the receiving unit plays low resolution video data.

After the video and audio are played, the receiving unit proceeds to step 517 to determine whether the video communication is finished or not. If the video communication is not finished, the receiving unit returns to step 503, and if the video communication is finished, the receiving unit finishes this procedure.

In a video communication system, a video communication service with a scalability technique is provided without additional DSP chip mounting, by using video encoders in a PDA chip and a modem chip of a compound terminal.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for a terminal having a video communication function, comprising:
a first video encoder, disposed in a personal digital assistant (PDA) chip, generating an enhanced layer bit sting for a high resolution video;
a second video encoder, disposed in a modem chip, generating a basic layer bit string for a low resolution video;
a control unit providing the enhanced layer bit string to the modem chip; and
a communication unit, disposed in the modem chip, transmitting the enhanced layer bit string and the basic layer bit string.

2. The apparatus of claim 1, further comprising a video processor generating high resolution video data and low resolution video data and providing the high resolution video data and the low resolution video data to the first video encoder and the second video encoder, respectively.

3. The apparatus of claim 2, wherein:
the second video encoder provides the low resolution video data to the control unit; and
the control unit provides the low resolution video data to the first video encoder.

4. The apparatus of claim 3, wherein the first video encoder generates extended low resolution video data by up-sampling the low resolution video data and, after difference between the high and low resolution video data is obtained, generates the enhanced layer bit sting by encoding the difference.

5. An apparatus for a terminal having a video communication function, comprising:
a communication unit, disposed in a modem chip, receiving an enhanced layer bit string and a basic layer bit string of a video for video communication;
a second video decoder, disposed in the modem chip, restoring low resolution video data from the basic layer bit string;
a first decoder, disposed in a PDA chip, restoring high resolution video data from the low resolution video data and the enhanced layer bit string; and
a control unit providing the low resolution video data to the first video decoder.

6. The apparatus of claim 5, wherein the first video decoder restores difference by decoding the enhanced layer bit sting and generates extended low resolution video data by up-sampling the low resolution video data, and then restores the high resolution video data by combing the extended low resolution video data and the difference.

7. The apparatus of claim 5, wherein the control unit determines whether the enhanced layer bit string is decoded or not based on a channel status of a transmitting unit.

8. A method for transmitting a video in a compound terminal having a video communication function, the method comprising:
generating an enhanced layer bit string for a high resolution video using a first video encoder in a PDA chip;
generating a basic layer bit string for a low resolution video using a second video encoder in a modem chip; and
transmitting the enhanced layer bit string and the basic layer bit string.

9. The method of claim 8, further comprising:
generating high resolution video data and low resolution video data;
providing the high resolution video data to the first video encoder; and
providing the low resolution video to the second video encoder.

10. The method of claim 9, wherein the generating of the enhanced layer bit string comprises:
generating extended low resolution video data by up-sampling the low resolution video data;
obtaining difference between the high resolution video data and the extended low resolution video data; and
generating the enhanced layer bit string by encoding the difference.

11. A method for receiving a video in a compound terminal having a video communication function, the method comprising:
receiving an enhanced layer bit string and a basic layer bit string of a video for video communication;
restoring low resolution video data from the basic layer bit string using a second video decoder in a modem chip; and
restoring high resolution video data from the low resolution video data and the enhanced layer bit string using a first video decoder in a PDA chip.

12. The method of claim 11, wherein the restoring of the high resolution video data comprises:
restoring difference by decoding the enhanced layer bit string;
generating extended low resolution video data by up-sampling the low resolution video data; and
restoring the high resolution video data by combining the extended low resolution video data and the difference.

13. The method of claim 11, further comprising determining whether the enhanced layer bit string is decoded or not based on a channel status of a transmitting unit.
